(19) United States
(12) Patent Application Publication
(10) Pub. No.: US 2002/0066430 A1
(43) Pub. Date: Jun. 6, 2002

(54) Starter for internal combustion engine

(75) Inventors: Sadayoshi Kajino, Nagoya-city (JP); Youichi Hasegawa, Kasugai-city (JP); Yasuo Osawa, Nitta-Gun (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 09/996,781

(22) Filed: Nov. 30, 2001

(30) Foreign Application Priority Data
Dec. 5, 2000 (JP) 2000-370684

(51) Int. Cl. F02N 11/00

(52) U.S. Cl. 123/179.25

(57) ABSTRACT

A starter for an internal combustion engine includes a planetary gear speed reduction mechanism, a pinion and a pinion drive shaft, a motor, a front housing having a plurality of fastening holes disposed at a circumference and a center casing having approximately the same outside diameter as the motor housing. The center housing is disposed between the motor housing and the front housing to align a motor shaft, the planetary gear speed reduction mechanism and the pinion drive shaft. The diameter of the motor housing is a maximum outside diameter of the fastening bolt less than the diameter of a circumference on which the fastening bolts are formed. Therefore, fastening bolts can be easily inserted into the fastening holes.

### CROSS REFERENCE TO RELATED APPLICATION

The present application is based on and claims priority from Japanese Patent Application 2000-370684 filed Dec. 5, 2000, the contents of which are incorporated herein by reference.

### BACKGROUND OF THE INVENTION

1. Field of the Invention

The present invention relates to a starter for an internal combustion engine and particularly, a starter for a large-sized diesel engine.

2. Description of the Related Art

A starter for a large-sized diesel engine employs a starter motor, a pinion gear to be engaged with a ring gear of a diesel engine and a planetary gear speed reduction mechanism disposed between the starter motor and the pinion gear. The speed reduction mechanism is necessary to provide a compact starter motor. In such a starter, the motor shaft of the starter motor and a pinion drive shaft are not coaxially connected. Usually, the motor shaft is supported by a motor housing, and the pinion drive shaft is supported by a front housing that has a flange which is fixed to a portion of the engine by a fastening bolt. Since the motor shaft and the pinion drive shaft are not coaxially disposed, the motor housing overhangs the flange. Therefore, it is impossible to mount such a starter on the engine by a common socket wrench. It was necessary to use a special tool to mount on or demount from such a starter on the engine.

### SUMMARY OF THE INVENTION

Therefore, a main object of the invention is to provide a compact starter for an internal combustion engine that can be mounted on an engine easily with a common tool such as a socket wrench.

According to a main feature of the invention, starter for an internal combustion engine includes a planetary gear speed reduction mechanism, a pinion to be engaged with a ring gear of the engine and a pinion drive shaft connected to the speed reduction mechanism, a motor having a motor housing, a front housing for supporting the pinion drive shaft at an end, a center casing for supporting the pinion drive shaft at the other end. The front housing has a flange to be fixed to a portion of the engine. The motor housing has a first outside diameter, and the flange has a plurality of fastening holes disposed at a circumference having a second diameter. The center housing is disposed between the motor housing and the front housing to align a motor shaft, the planetary gear speed reduction mechanism and the pinion drive shaft. A difference between the first outside diameter and the second diameter is larger than a maximum outside diameter of the fastening bolt so that the fastening bolt can be inserted into the fastening hole along the outer periphery of the motor housing.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a starter for an internal combustion engine according to a preferred embodiment of the invention;

FIG. 2 is a schematic front view of a center housing connected to a motor housing of the starter according to the preferred embodiment;

FIG. 3 is a schematic diagram illustrating variations of assembling the starter according to the preferred embodiment;

FIG. 4 is a rear view of the starter according to the preferred embodiment;

FIG. 5 is a graph showing relationship between motor current and the outside diameter of a starter motor;

FIG. 6 is a graph showing relationship between the motor current and the speed reduction ratio of a planetary gear speed reduction mechanism;

FIG. 7 is a graph showing relationship between the output power of the starter motor and the outside diameter thereof; and

FIG. 8 is a graph sowing relationship between the rotation speed of a pinion of the starter and the outside diameter of the starter motor.

### DETAILED DESCRIPTION OF THE PREFERRED EMBODIMENTS

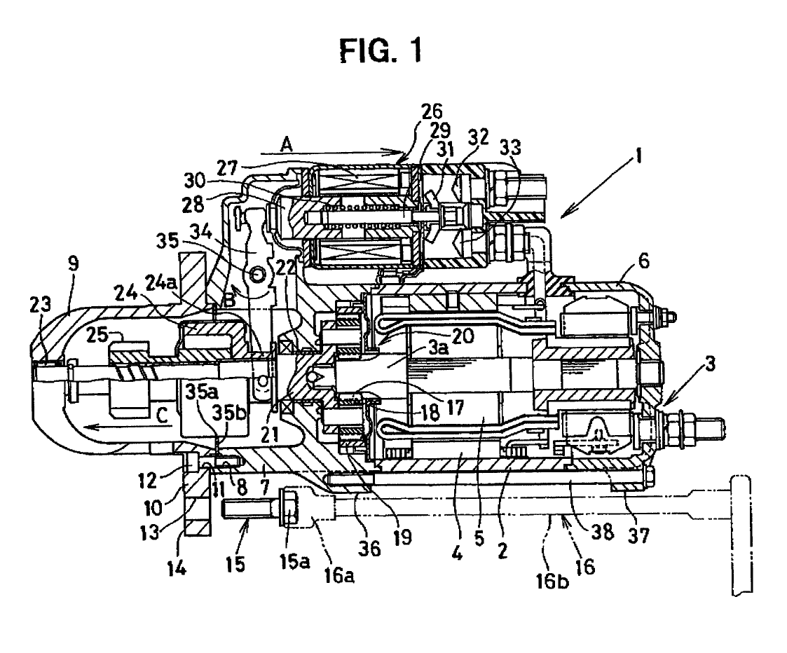

A starter 1 for a large-sized diesel engine that has a capacity between 10-16 litters is shown in FIG. 1. A starter motor 3 is comprised of a motor housing 2, a stator 4, a rotor 5 disposed in the stator 4 and a motor shaft 3a force-fitted to the rotor 5. An end frame 6 is fixed to the rear portion of the motor housing 2, and a center casing 7 is fixed to the front portion thereof.

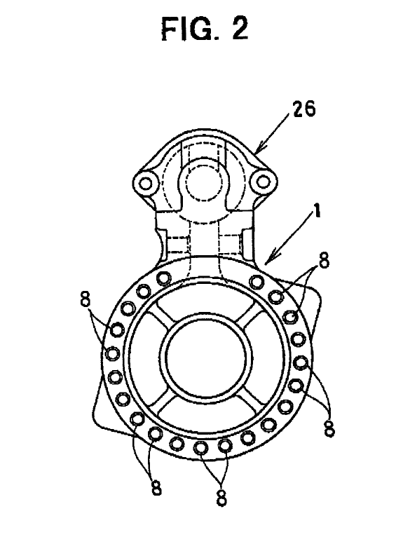

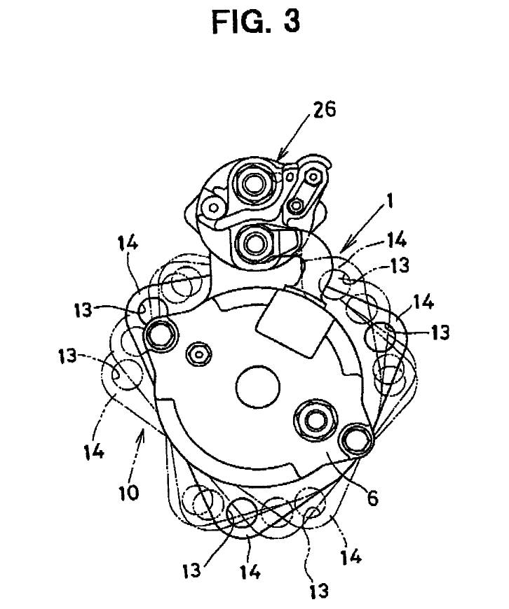

A plurality (e.g. twenty one) of female screws 8 is formed at the front surface of the center casing 7 at equal intervals except for an upper portion thereof, as shown in FIG. 2. A cup-shaped front housing 9 has a flange 10 at the open end thereof, where a plurality (e.g. six) of through holes 11 is formed at portions corresponding to the female screws 8. The flange 10 also has three ear-like fixing portions 14 projecting radially outward from the outer periphery thereof at equal intervals. Each of the fixing portions 14 has a fastening hole 13. The front housing 9 is fixed to the front surface of the center casing 7 at the flange 10 by a plurality (e.g. six) of bolts 12 that is screwed into a portion (e.g. six) of the plurality (e.g. twenty one) of the female screws 8 via the through holes 11. As shown in FIG. 3, the front housing 9 can be fixed to the center casing 7 at a most appropriate angular position of the center casing 7 so that the starter 1 can be on a different engine.

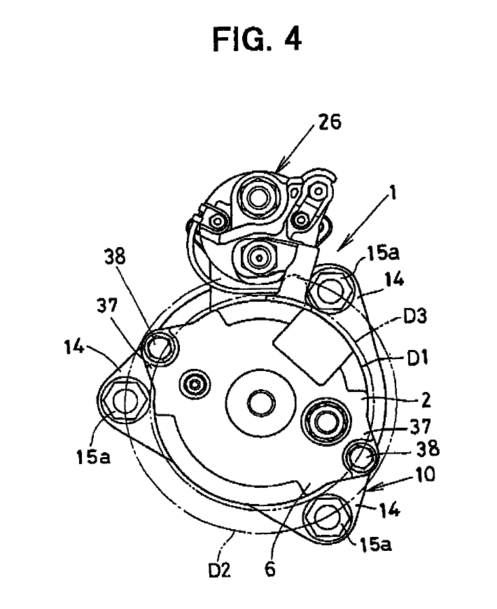

The motor housing 2, the end frame 6 and the center casing 7 have nearly the same outside diameter D1. The starter 1 is fixed to a bracket (not shown) of the engine by three fastening bolt 15 at the fastening holes 13. The fastening holes 13 are formed on a circumference of a diameter D2 to prevent the motor housing 2 from obstructing the heads 15a of the fastening bolts 15 being inserted into the fastening holes 13, as shown in FIG. 4. In other words, the outside diameter D1 is made smaller than an inscribed circle D3 of the head of the fastening bolts 15. That is, the outside diameter D1 is a maximum outside diameter of the fastening bolt less than the diameter D2 of the circumference on which the fastening holes are formed. Accordingly, a fixing tool, such as a socket wrench 16, can have access to the heads 15a of the fastening bolts 15 around the motor housing 2.

The end frame 6 and the center casing 7 respectively have two pairs of radially projecting fixing portions 36 and 37 and are fastened to each other by two fastening bolts 38 at the fixing portions 36 and 37. They are located away from the three fixing portions 14 of the front housing 9 so as not to obstruct the socket wrench 16, as shown in FIG. 4.

The motor shaft 3a extends to the inside of the center housing 7 and carries a sun gear 17 of a planetary gear speed reduction mechanism 20 that is comprised of planetary gears 18 and an internal gear 19. The planetary gears 18 are fixed to the rear portion of a drive shaft 21, and the internal gear 19 is fixed to the inner wall of the center casing 7.

The drive shaft 21 is supported at the rear end thereof by the center housing 7 via a rear bearing 22 and at the front end by the front housing 9 via a front bearing 23 so that the drive shaft 21 can be coaxial with the motor shaft 3a. An over running clutch 24 and a pinion 25 are carried by the drive shaft 21 so that they can reciprocate along the drive shaft 21.

An electromagnetic plunger 26 is disposed on the motor housing 2 and the center housing 7. The electromagnetic plunger 26 is comprised of an electromagnetic coil 27, a plunger 28, a rod 29, a compression coil spring 30, a contact bridge 31 and a pair of stationary contacts 32 and 33. The coil spring and the rod 29 are disposed inside the electromagnetic coil 27. The contact bridge 31 is fixed to the end of the plunger 28 that projects from the electromagnetic coil 27 to face the pair of stationary contacts 32 and 33.

A lever 34 is rotatably supported by a pin 35. The lever 34 is fixed at the upper end thereof to a front portion of the plunger 28.

A ring-shaped dust seal 35b is disposed between the flange 10 and the center casing 7 so that the inner edge 35a of the dust seal 35b contact the outer periphery of the overrunning clutch 24, thereby keeping dust off the inside of the center housing 7.

When a key switch is turned on, the electromagnet switch 27 is energized to move the plunger 28, together with the rod 29, in a direction indicated by an arrow A. Consequently, the lever 34 rotates about the pin 35 in a direction indicated by an arrow B. Therefore, the pinion 25, together with the overrunning clutch 24, is moved along the drive shaft 21 in a direction indicated by an arrow C to engage a ring gear (not shown) of the engine.

When the plunger 28 moves in the direction indicated by the arrow A, the rod 29 urges the contact bridge 31 against the stationary contacts 32 and 33 and closes the power circuit of the motor 3. Accordingly, the motor shaft 3a rotates the drive shaft 21 via the sun gear 17 and the planetary gears 18 of the planetary gear speed reduction mechanism 20. Thus, the ring gear is rotated, and the engine is started.

If the diameter of the circumference for the fastening holes is 146 mm and if the outside diameter of a socket wrench is 28 mm, the outside diameter D1 of the motor housing should be 118 mm or less.

It is generally known that the heat capacity of the motor is proportional to D1²×L, where L is an axial length of the motor. If the length is not increased, motor current should be reduced in order to suppress temperature rise of the motor. Further, it is necessary to increase the output torque of the motor by increasing the speed reduction ratio of the planetary gear speed reduction mechanism 20.

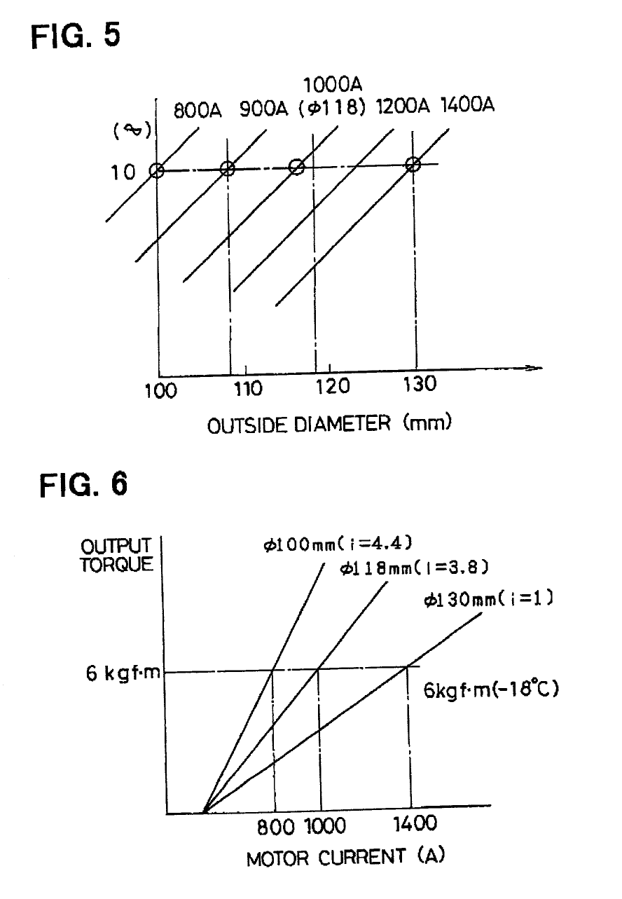

If the output torque of a sample starter motor whose outside diameter is 130 mm is 6 kg·m/1400 A, it is possible to attain 6 kg·m/1000A by a starter motor whose outside diameter is 118 mm, as shown in FIG. 5. Further, the speed reduction ratio has to be more than 3.8, according to a graph shown in FIG. 6.

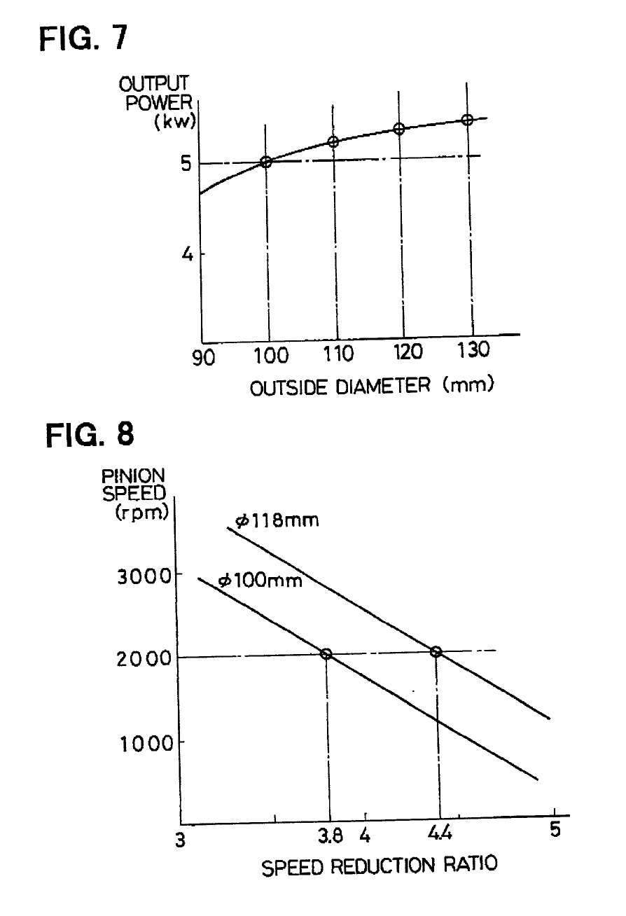

If the output power of 5 kw is necessary, the outside diameter has to be larger than 100 mm, according to a graph shown in FIG. 7. The outside diameter of larger than 100 mm can be attained if the speed reduction ratio is equal to or less than 4.4. FIG. 8 shows that the outside diameter between 100 mm and 118 mm will rotate the pinion at 2000 rpm with the speed reduction ratio being between 3.8 and 4.4.

Thus, a compact and powerful starter that has the starter motor whose outside diameter is in the range of 100 mm -118 mm, and the planetary gear speed reduction mechanism whose speed reduction ratio is in the range of 3.8-4.4.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense.

What is claimed is:

1. A starter for an internal combustion engine including a planetary gear speed reduction mechanism, a pinion to be engaged with a ring gear of said engine and a pinion drive shaft connected to said speed reduction mechanism comprising:
a motor having a motor housing with a first outside diameter and a motor shaft;
a front housing having a flange for supporting said pinion drive shaft, said flange having a bearing for supporting said pinion drive shaft at an end of said shaft and a plurality of fastening holes disposed at a circumference having second diameter through which a plurality of fastening bolts is fixed to a portion of said internal combustion engine; and
a center casing having approximately the same outside diameter as said motor housing and a bearing for supporting said pinion drive shaft at the other end, said center housing being disposed between said motor housing and said front housing for aligning said motor shaft, said planetary gear speed reduction mechanism and said pinion drive shaft,; wherein
a difference between said first diameter and said second diameter is larger than a maximum outside diameter of said fastening bolt so that said fastening bolt can be inserted into said fastening hole along outer peripheries of said motor housing.

2. The starter as claimed in claim 1, wherein said difference is larger than a maximum outside diameter of a socket wrench.

3. The starter as claimed in claim 2, further comprising an end frame having a plurality of radially projecting fixing portions disposed away from said fastening holes so as not to obstruct said socket wrench.

4. The starter as claimed in claim 1, therein
said first outside diameter of said motor housing is between 100 mm and 118 mm, and
said planetary gear speed reduction mechanism has a speed reduction ratio between 3.8 and 4.4.

5. The starter further comprising a dust seal disposed between said front housing and said center housing.
